(19) United States
(12) Patent Application Publication
(10) Pub. No.: US 2016/0226180 A1
(43) Pub. Date: Aug. 4, 2016

(54) IMPROVEMENTS TO ELECTRICAL CONNECTORS AND THEIR MANUFACTURE

(71) Applicant: CUSTOM INVESTMENTS LIMITED, Honk Kong (CN)

(72) Inventors: Poya Shakibaee, Wembley, WA (AU); Arash Shakibaee, Mosman Park, WA (AU)

(21) Appl. No.: 15/022,299

(22) PCT Filed: Sep. 19, 2014
(86) PCT No.: PCT/AU2014/050241

§ 371 Date: Mar. 16, 2016

(30) Foreign Application Priority Data
Sep. 19, 2013 (AU) 2013903619
Jul. 25, 2014 (AU) 2014902898

(51) Int. Cl. H01R 13/58; H01R 12/77; H01R 43/20; H01R 13/53

(52) U.S. Cl. CPC H01R 13/5845; H01R 13/53; H01R 12/772; H01R 43/20

(57) ABSTRACT

An electrical connector (110) and a method of manufacture thereof provides an electrical end connector (112) operatively and physically connected to an electrical cable (114). A metal body portion (124) internally structurally supports a metal sleeve (130) having at least one side wall (132) and an end wall (134). Alternatively, an electrical connector (10,40) has multiple portions (12,14,42,44), which, when stored are connected laterally together, and in use can be laterally disconnected from each other though remaining longitudinally electrically connected relative to one another. The multiple portions include a protective covering over respective first and second regions of the electrical conductor, and a third region (18,22) of the electrical conductor intermediate the first and second regions being exposed from the protective coverings provided by the first and second portions.

### FIELD OF THE INVENTION

The present invention relates to electrical connectors, such as for physically connecting one electrical device to another for power and/or data transfer.

The present invention further relates to manufacture and structure of electrical connectors.

### BACKGROUND TO THE INVENTION

Portable electrical devices are typically connected to a power source for electrical operation or battery charging, or to another electrical device for transfer of data, or both.

The form of connection between one and the other is normally a flexible cable. The cable consists of an electrically conductive core extending between two electrical connectors, one at each end of the core. The core and connectors are sheathed in an insulating material, typically a plastic coating, to prevent short circuiting and to protect the core and connectors from wear and tear.

The connector ends of the cable are relatively bulky, partly because of the size of the electrical connector employed, and partly because of the design and thickness of the plastic jacket or coating over the connector, which jacket or coating is not only used as an electrical insulator but often also serves as the grip portion when inserting/removing the connector to/from connection with the electrical device.

Modern portable personal electrical devices, particularly smartphones, tablets, palmtops, e-readers and laptops, are power hungry, having to run many applications, run colour screens, in-built cameras, illuminate their keyboards etc., and yet there is a drive to reduce their physical size, which affects battery size and ultimately battery power. Although battery technology is improving, with battery energy density generally increasing, there is still a major need to connect such personal electrical devices to an electric power supply for charging or operation. This is particularly the case when the user is travelling.

Also, in an effort to reduce physical size, the connector socket on the device creates a minimum size dimension that the device cannot be any thinner than at that connection point.

Further more, connector cables are relatively bulky, particularly if more than a very short length of cable is required. Also, the typical round core section of a connector cable and the relatively bulky connectors create transport and storage problems, particularly when a user is travelling with minimum personal effects, few pockets or without a travel bag. It is also very inconvenient for a user to try to find a location with a suitable connector if they need power or data transfer, and users would prefer not to have to purchase a new connector cable for a one time use.

It has also been realised that some electrical connections provided at the ends of electrical cables, such as at the ends of cables used to connect an electric charger or data port to a portable device (smartphone, tablet, laptop etc.) lack sufficient structural integrity to reliably protect the internal electrical connections and any components within the end connector from damage, such as by crushing or impact or flexing or twisting. Structural rigidity typically comes from the plastic over-moulding injected over and around the connections between the cable and connector. Sometimes a metal jacket is applied around the plastic over-moulding for aesthetic purposes and to give some structural resilience; however, the connector relies predominantly on the plastic over-moulding for strength and rigidity to protect the delicate internal electrical connections to connector and any circuit connections within the connector.

As portable personal devices, such as smartphones, tablets and laptops get smaller and smaller, there is a need to make data ports/charging parts and cable connections smaller to suit. Consequently, the end connectors on cables also need to reduce in size, and for practical portability of cables without being too cumbersome or take up too much room in a pocket or bag, particularly when travelling. Limited battery life of power hungry devices with relatively large, bright screens, and the need for almost instant connectability of such personal portable devices, demand that a suitable connector cable be readily available. However, as a result of reducing size of cable connectors, structural integrity can suffer.

Plastic over-moulding provides some structural integrity by helping to bond the cable sheath to the end connector, but with such small size of modern connectors, particularly as the demand for smaller and smaller connectors grows, the restricted amount of plastic over-moulding risks loss of inherent strength of the end connector and protection for the internal connections and components therein.

With this in mind, it is desirable to provide an electrical connector, such as a cable with end connectors, that has enhanced structural integrity of the end connector(s) and improved protection for internal connections.

It is further desirable to provide a structurally enhanced end connector for an electrical (cable) connector, such as for a data or charging cable.

### SUMMARY OF THE INVENTION

It has been realized that there is an advantage in providing an electrical connector for use in connecting electrical devices for power and/or data transfer wherein the electrical connector is highly portable, can be transported in a purse, pocket, credit/debit card holder or wallet, or on a key ring/chain.

There is also an advantage in providing an electrical connector having 360 degree rotation of the connector end at one end thereof relative to the connector end at the other end thereof.

Another desirable advantage can also be realized by enabling at least two portions of the electrical connector to be secured together when required e.g. when not in use, providing a much reduced and manageable stored length relative to the unsecured or expanded length when needed for use

With the aforementioned in mind, an aspect of the present invention provides an electrical connector to, in use, electrically connect two electrical devices for power and/or data transfer from one said device to the other, the electrical connector having at least first and second portions, each of the first and second portions including a respective electrical end connection to electrically engage with a respective one of the electrical devices, the electrical end connections connected together by an electrical conductor, each of the first and second portions including a protective covering over respective first and second regions of the electrical conductor, and a third region of the electrical conductor intermediate the first and second regions being exposed from the protective coverings provided by the first and second portions.

One or more benefits can also be realized by providing over-moulding along a significant length of each portion of the electrical connector, which helps to provide long lasting product durability. Such over-moulding may extend over an end connector leaving electrical contacts exposed for electrical connection and also a significant portion of the length of the electrical connector.

Preferably the over-moulding is or includes a semi-rigid material, such as polyester or PPS plastic or other thermoset plastic.

Each portion of the electrical connector may include such over-moulding. The over-moulding can cover and/or protect a part of at least one flexible insulated electrical conductor that extends between one end connector to the other. The insulated electrical conductor may include a flexible insulated electrical cable. Part of the insulated cable may be exposed from the over-moulding between one portion of over-moulding and the next. This advantageously provides flexibly at those spacings between the over-moulding portions.

Advantageously, one or more benefits of the present invention provides a balance between portability, length, 360 degree flexibility and durability.

Standard cables provide the length but are not convenient to carry around or on one's person because of their relative bulk. Shorter cables are perceived as providing a better level of portability but because they use standard size connectors with bulky over-moulding, they still require a handbag or other personal storage to be convenient to be carried at all times.

Preferably the electrical conductor is insulated by a coating of PTFE (Polytetrafluoroethylene—a synthetic fluoropolymer of tetrafluoroethylene) thereby providing a thin yet strong protective layer over the electrical conductor whilst maintaining flexibility of the electrical connector when in use and protecting the electrical conductor third region that is exposed between the first and second portions.

Preferably the insulation over the electrical conductor extends through the first and second portions.

This allows for the electrical conductor to be overmoulded by the first and second portions and still maintain a relatively very thin, from 2.5 mm, thickness compared to other connectors.

The end connector at one or both ends of the electrical connector may preferably be formed with an insulating over-moulding. The over-moulding may be formed over a printed circuit board (PCB) and/or electric connector pins (such as ‘GoldFinger’ connectors) to provide reduced external size yet providing exact external size to suit the female USB connectors.

Use of improved connectors (micro USB) in combination with the over moulding helps to maintain a reduced thickness compared with known connectors. Thus, the electrical connector at the end connectors may be as thin as 2.5 mm.

360 degrees rotation of one end connector relative to the other is achieved by having a discontinuity in the covering of one of the first and second portions relative to the other. This can be provided by a discontinuity in respective over-moulding on the first and second portions,

The electrical conductor can therefore continue from one end connector to the other with over-moulding at the first and second portions and the insulated conductor remaining flexible where it is exposed between over-moulded portions. Thus, the electrical connector may be sectional in the sense that each portion of over-moulding over the electrical conductor creates a section and the electrical conductor (within its sheath/insulation layer continues between sections as it extends from one end connector to the other.

The first and second portions may also be flexible or semi-flexible. Preferably the first and second portions are resiliently flexible, so that if deformed, such as by bending or twisting, they return to their original shape. Preferably this is achieved by forming the first and second portions as over-moulded plastic on the electrical conductor with a discontinuity between over-moulded portions allowing the flexible electrical conductor to extend from one over-moulded portion to the other and permit relative movement between the first and second portions.

Flexibility along the length of either or each of the first and second portions may be enabled or assisted by apertures through the over-moulding.

Connection means may be provided to releasably connect the first and second portions directly to each other or via one or more further portions. The connection means enables convenient storage and transport of the electrical connector as a single unit without the problems associated with standard flexible cables i.e. uncoiling or unravelling and minimal protection.

The connection means may releasably connect one portion to another. For example, in a two portion electrical connector, the first and second portions may releasably connect. In a five portion electrical connector, each portion connects to at least one other of the portions, the three portions (third, fourth and fifth portions) intermediate the first and second portions connect to the two adjacent portions. For example, the third portion connects to the first and fourth portion, while the fourth portion connects to the third and fifth portions, and the fifth portion connects to the fourth and second portions).

The connection means may include at least one projection on one of the portions releasably engaging with a recess on another of the portions, or vice versa. Each portion may have at least one projection and at least one recess to engage respectively with a recess and a projection on an adjacent one of the portions. Alternatively, one of the portions may have the projection(s) and an adjacent one of the portions may have the recess(es). Intermediate ones of the portions may have both projections and recess to inter-engage with respective recess(es) and projections on adjacent portions either side thereof for storage and transport.

Furthermore, the relatively thick and bulky nature of standard connection cables makes them uncomfortable or inconvenient to carry on one's person. To the contrary, embodiments of the present invention are rendered relatively thin by the structure of the flexible conductor and over-moulding.

As will be appreciated, durability is provided in one or more embodiments of the present invention by over-moulding protective material along a majority of the length of the electrical connector.

The present invention may utilize improved connectors for better integration with the over-moulding resulting in greater overall strength and durability of the product.

Longer length embodiments of the present invention can be provided by having one or more additional portions intermediate the first and second portions, with the electrical conductor exposed between each covered portion.

An electrical connector of the present invention may comprise two interlocking portions to create a length of approximately 170 mm. The number of sections can be increased. Five portions joined together will allow the connector to fit into a credit card slot in a wallet, purse, card holder etc, That is, the electrical connector can be made approximately credit card size in width and height and thickness.

Solid state memory may be incorporated within the electrical connector of the present invention so that the product can double as a flash memory/thumb drive/memory stick. Such solid state memory may be protected by the over-moulding, and may be electrically connected to the end connectors or may have discrete connectors not connected to the electrical conductor and thereby may function separately from the electrical conductor.

A further form of the present invention provides an electrical connector which, in use, electrically connects two electrical devices for power and/or data transfer from one said device to the other, the electrical connector having at least first and second opposed end connectors electrically connected by an insulated electrical conductor, each of the first and second opposed end connectors including a protective covering over at least a portion of the respective end connector, and at least one of the end opposed end connectors having, the covering extending over a distal end thereof and having exposed electrical contacts for connection with a said electrical device.

The insulated electrical conductor may comprise at least one flexible flat cable (FFT) electrically connecting the first and second opposed end connectors. It will be appreciated that the flexible flat cable may include multiple electrical conductors extending along a length of the flexible flat cable. Preferably the multiple electrical conductors are provided as strips or tracks of electrically conductive material, some or all of which may be electrically connected to the first and second opposed connectors. The FFC reduces thickness of the insulated cable compared to round or oval core cable, and is readily coiled for storage and transport.

Known round core cable with multiple insulated conductors within an overall insulated outer sheathing takes up considerable volume/space. Much of the space within the cable is taken up by the insulating material or air gaps between the multiple runs of conductors. It has been realized that it would be beneficial to provide a connector cable that has reduced thickness for improved storage and transport characteristics.

Preferably the flexible flat cable (FFC) is provided as a ribbon cable. The FFC may comprise of a flat and flexible plastic film base, with multiple metallic conductors bonded to one surface or within a sheath or covering of an insulating material, such as a plastic e.g. polyester.

The protective covering on the respective end connectors may include a tension relief means to protect connection between the electrical conductor and the respective end connector. Tension relief may be provided by one or more internal projections from the protective covering engaging with one or more respective recesses on or in a portion of the respective end connector.

The respective end connector includes a body and one or more electrical contacts. The body may be of or include metal, such as a metal connector e.g. a micro-USB connector.

Exposed electrical contacts on the end connectors may provide contact terminals surrounded peripherally by over-moulded protective covering.

One or more apertures may be provided through or into the protective covering to provide additional flexibility at the connector ends.

A further aspect of the present invention provides an electrical connector having an electrical end connector operatively and physically connected to an electrical cable via at least one electrical cable connection, a metal body portion and at least one electrical contact for transfer of electrical signals between at least one corresponding contact to which the electrical end connector is engaged, and the electrical end connector including a metal sleeve having at least one side wall, the side wall extending to cover the metal body portion, the metal body structurally supporting the side wall.

Preferably, the metal body portion is in direct contact with the side wall of the sleeve and/or in contact with the end wall. More preferably, the metal body portion provides structural support for two opposed faces of the at least one side wall. Thus, the metal side wall of the sleeve may be supported across the width and/or thickness of the end connector by the metal body portion, thereby providing enhanced anti-crush and anti-damage structural integrity to the end connector. The metal sleeve in combination with the internal metal body portion of the end connector enhances structural strength to resist wear and tear and mishandling. This structural arrangement of the end connector is particularly beneficial as electrical end connectors tend to be made smaller and smaller as the devices they connect to have smaller sockets for data and charging connection. Smaller sockets on such devices enable the entire device to be made smaller (usually thinner) to meet with user/consumer need or desire for smaller yet highly functional devices, though this makes the smaller connectors more vulnerable to damage because of lower structural rigidity. Providing an end connector that maintains required functionality and yet exhibits improved structural strength results in a more reliable connection to the device.

The end connector may include plastic moulding over the at least one electrical cable connection. More preferably the plastic moulding may be over a portion of the body.

The metal side wall of the sleeve may extend to cover the electrical cable connection. Preferably the sleeve includes an end wall, the end wall preferably including an opening through which the at least one electrical contact of the electrical end connector projects externally of the sleeve.

Preferably the sleeve is formed as a one piece metal component incorporating an integral said end wall and said side wall.

The electrical end connector may include a substrate, such as a printed circuit board, supporting the at least one electrical cable connection. The substrate or printed circuit board may provide structural support for electrical connection between the electrical cable connection(s) and the electrical contact(s).

Plastic over-moulding that covers the at least one electrical cable connection may further extend along a portion of the cable external and adjacent the sleeve.

The opening in the end wall of the sleeve may include a slot through which the at least one electrical contact extends on a portion of the body. Thus, the body may include a portion within the sleeve and a portion supporting the at least one electrical contact extending through the opening.

The sleeve may be pressed or stamped as a single component from sheet metal.

During manufacture of the electrical connector, the cable may be connected to the end connector, such as by soldering electrical wires in the cable to respective electrical contact points on the end connector, the metal sleeve may be applied over the metal body portion with the electrical contacts projecting externally from the opening of the metal sleeve, and the plastic over-moulding provided to fill the space created between the metal body portion and the inside surface of the side wall of the metal sleeve and end wall.

Thus, during manufacture, the metal sleeve becomes an integral part of the end connector.

Alternatively, after the plastic material is over-moulded onto the cable electrical connection(s), the metal sleeve may be applied over body and at least part of the over-moulding, and may preferably be bonded to the metal body portion and/or over-moulding, such as by an adhesive or other bonding agent.

A further aspect of the present invention provides a method of manufacturing an electrical connector, including the steps of:
connecting an electrical cable to an end connector;
applying plastic over-moulding over the connection of the cable to the end connector; and
applying a metal sleeve over a metal body portion of the end connector and over the connection between the cable and end connector, such that the metal body portion provides structural support to the side wall of the metal sleeve.

Thus, through manufacture, the metal body portion of the end connector gives internal support for a side wall of the end connector.

The metal sleeve may be formed as a one piece component, preferably prior to applying over the metal body portion. The side wall of the metal sleeve may be approximately 0.3 mm thick metal, and preferably formed of stainless steel. Overall external dimensions of the sleeve may preferably be approximately 10 mm wide and up to 3.5 mm thick. Thus, the external width and thickness dimensions of the connector are the same as the external metal sleeve.

The metal sleeve may be formed including an end wall with at least one opening therethrough, a portion of the body of the end connector extending through the at least one opening.

The method of manufacture may include bonding the metal sleeve to the over-moulding. Such bonding may include bonding the sleeve to the over-moulding with an adhesive.

### BRIEF DESCRIPTION OF THE DRAWINGS

One or more embodiments of the present invention will hereinafter be described with reference to the drawings, in which:

FIGS. 1a to 1f show various views of an electrical connector according to an embodiment of the present invention. FIG. 1a shows a plan view, FIG. 1b shows a reverse side plan view, FIG. 1c shows a side edge view of one section of the electrical connector FIG. 1d shows a side edge view of the other section of the electrical connector, FIG. 1e shows an end view of the section shown in FIG. 1c, and FIG. 1f shows an opposite end view of the section shown in FIG. 1c.

FIGS. 2a to 2h show various views of an electrical connector according to an alternative embodiment of the present invention. FIG. 2a shows a plan view, FIG. 2b shows a reverse side plan view, FIG. 2c shows a side edge view of one section of the electrical connector, FIG. 2d shows a side edge view of the other section of the electrical connector, FIG. 2e shows an end view of the section shown in FIG. 2c, and FIG. 2f shows an opposite end view of the section shown in FIG. 2c, FIG. 2g shows an end view of the section shown in FIG. 2d and FIG. 2h shows the opposite end view of the section shown in FIG. 2d.

FIG. 3 shows an electrical connector according to an embodiment of the present invention ready for use with the connectable sections disengaged from each other yet remaining attached via the flexible electrical conductor.

FIG. 4 shows an electrical connector according to a further embodiment of the present invention in a credit card sized format with multiple sections shown engaged together in a storage configuration.

FIGS. 5 to 7 show various views of alternative forms a further embodiment of the present invention.

In particular, FIG. 5, 5A to 5C show respective exterior front, side and rear views of an end connector with protective covering according to an embodiment of the present invention. FIG. 5, 5D shows a longitudinal section through the end connector and protective covering. FIG. 5, 5E to 5G show longitudinal cross sections through the end connector and protective covering.

FIG. 6, 6A shows the end connector of FIG. 5 in perspective. FIG. 6, 6B, 6C show connector end views.

FIG. 7, 7A to 7C show respective exterior front, side and rear views of an end connector with protective covering protecting a flat, memory card type connection according to an embodiment of the present invention. FIG. 7, 7D shows a longitudinal section through the end connector and protective covering seen in FIG. 7, 7A to 7C. FIG. 7, 7D shows an end view revealing the protective covering over the distal end of the end connector.

FIG. 8 shows an end connector (plug) on a cable, the end connector incorporating a protective metal sleeve according to an embodiment of the present invention.

### DESCRIPTION OF PREFERRED EMBODIMENT

Various embodiments of the present invention are hereinafter described with reference to the accompanying drawings.

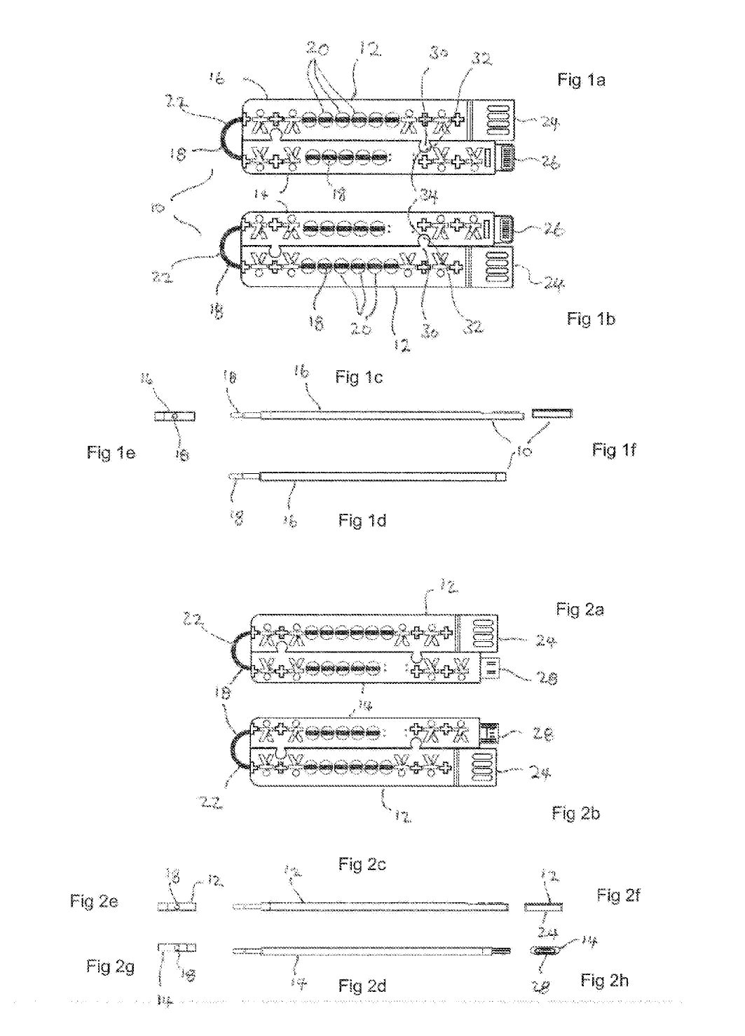

As shown in FIGS. 1a to 1f, an embodiment of the electrical connector 10 of the present invention has two portions, a first portion 12 and a second portion 14.

Each of these portions includes a protective over-moulding 16 covering a respective region of an insulated electrical conductor 18. The over-moulding is a thermoset plastic providing resilient flexibility and protection to the over-moulded regions of the electrical conductor.

Apertures 20 through the over-moulding can be sized to control the amount of desired flexibility relative to thickness and protection given by the over-moulding.

The insulated electrical conductor 18 has an exposed region 22 between the first and second portions 12,14. The insulation is a PTFE material, preferably Teflon®. The insulated region provides flexibility between the over-moulded portions thereby allowing relative movement through 360° rotation along the axis of the electrical conductor as well as radial degrees of freedom between the two portions 12,14. Thus, the electrical connector can be positioned and is adaptable to connect between electrical devices in different positions, and yet is protected for transport and storage when not in use.

Electrical connections are provided at each end 24,26 of the connector. End connector 24 is shown as a flat ‘goldfinger’ connector whilst end connecter 26 is shown as a proprietary device connector.

FIGS. 2a to 2h show an alternative embodiment of the electrical connector of FIGS. 1a to 1f, with one of the end connectors 28 provided as a micro-USB connector.

The first and second connectors 12,14 are releasably connected by connection means 30 comprising releasable interlocking projections and recess. A projection 32 engages with a recess. In the embodiments show in FIGS. 1a to 2h, two projections and respective recesses are provided spaced along the length of the first and second portions. In use, the projections engage into the recess for storage and transport of the electrical connector.

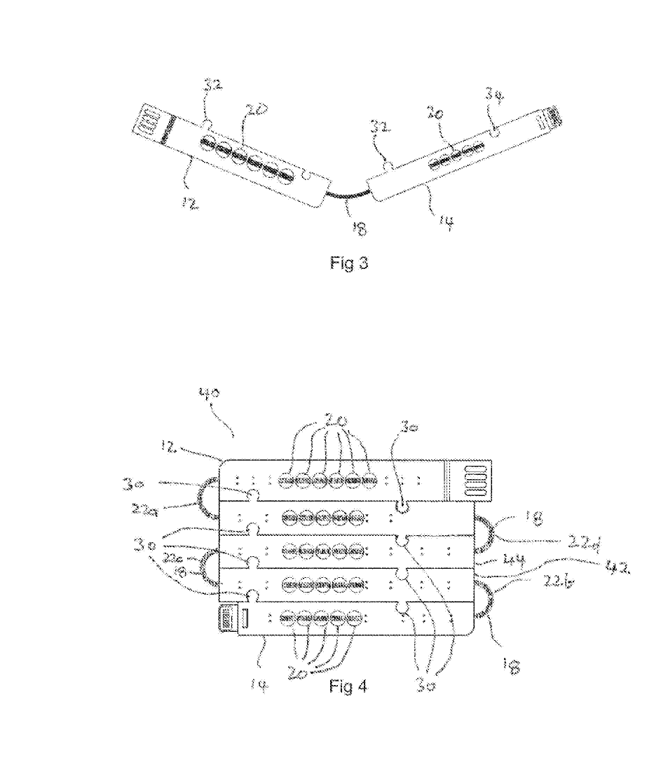

As shown in FIG. 3, the first and second portions 12,14 are separated by pulling the projections 32 out of the respective recesses 34. The intermediate exposed region 18 of the insulated electrical conductor maintains integrity of the connector.

FIG. 4 shows a longer version of the electrical connector 40 having five portions interconnected by respective exposed regions 22a to 22d of the insulated electrical conductor 18 extending through the electrical connector.

As is shown, each of the portions 12,14,42,44,46 is connected to at least one other of the portions by the respective releasable connection means 30 using the projections 32 and recesses 34 arrangement as described above.

The projections may be formed as part of the over-moulding or may be additional components attached to the over-moulding or to an underlying structure.

The electrical connector of claim 15, the protective covering providing a tension relief means to protect connection between the electrical conductor and the respective end connector.

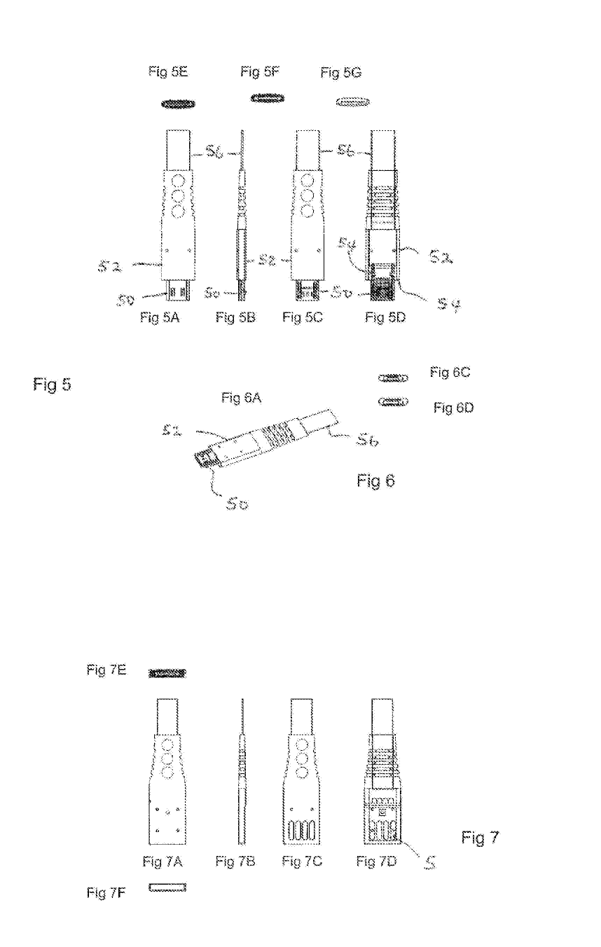

As shown in FIG. 5, 5A to G, the relatively flat end connector 50 has corresponding relatively flat over-moulding 52.

The end connector 50 may include one or more recesses or projections 54 providing physical grip regions for the over-moulding to bond to and provide additional strain relief for the insulated electrical conductor 56 which is attached to the contacts of the end connector by micro soldering or push fit connection.

The insulated electrical conductor 56 is a flexible flat cable (FFT) as shown. The FFT includes multiple electrical conductors running within the outer insulating covering. Reduced overall thickness of the electrical connector is achieved by using the FFC connected to low profile electrical connectors at each end of the ‘cable’ (electrical connector). The electrical connector can be termed a connector cable i.e. to connect two electrical devices together, such as a voltage step-down battery charger to a personal electrical device e.g. a laptop or tablet device, or to connect two electronic devices to each other to transfer data and/or power.

One or both of the first and second opposed end connectors may include a printed circuit board (PCB) supporting electrical contacts which are exposed through the outer protective coating for electrical connection to an electrical device. The PCB may also have electrical contact portions for contact with the conductors of the FFC. Thus, an extremely low profile connector cable is achieved because of the minimal height PCB and FFC combination.

Exposed electrical contacts can be contact terminals surrounded around a periphery thereof by the moulded protective covering.

For example, as shown in FIG. 7, 7A to 7E, the end connector can be provided as a flat memory card type connection, such as with ‘goldfinger’ contact pads.

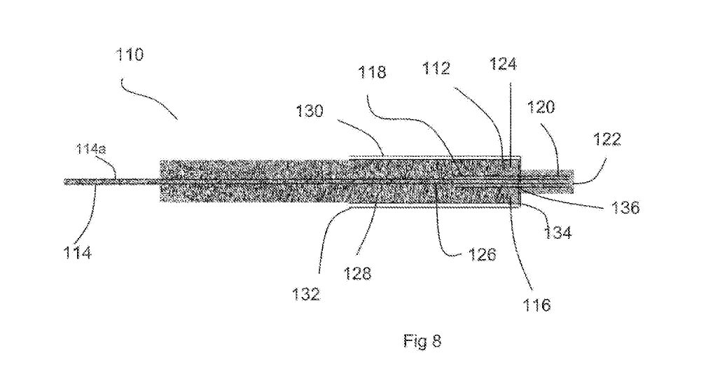

A shown in FIG. 8, an electrical connector 110 has an end connector 112 (such as a male plug) connected to a cable 114.

The end connector 112 includes a body portion 116 connected to a printed circuit board 118 (PCB). The cable includes electrical wires that connect to electrical connection points on the PCB. Electrical connections 120 connect from the electrical connection points on the PCB to external contacts on a distal end of the end connector (plug) 122.

A portion of the body 124 and the end of the cable 126 connected to the PCB are over-moulded with a plastic material 128.

A metal sleeve 130 covers the body portion 124 and cable connections to the PCB for added structural integrity and strength for the end connector. The side wall 132 of the metal sleeve can be supported by the body portion 124 of the connector. However, preferably the body portion directly contacts the internal surface of the metal sleeve. Preferably the body portion of the end connector is of metal, thereby providing structural support through the connector from one external side of the sleeve to the other. Thus, essentially, the end connector has strong metal support structure formed by the internal body portion bridging internally within the connector between the internal face(s) of the side wall(s) of the metal sleeve. Preferably the support by the body portion extends continuously around the inside surface of the metal sleeve, thereby providing all around structural support and rigidity to resist external crushing or impact pressure.

Preferably the metal sleeve is bonded or otherwise physically attached to the over-moulding. The metal sleeve has a continuous side wall 132 around the entire circumference of the end connector, with an opening 136 in an end wall 134 of the metal sleeve. The sleeve can be formed as a one piece unit, such as by stamping or pressing from stainless steel.

The end 122 of the plug extends through the opening in the metal sleeve end wall to allow for electrical connection, whilst the body portion within the sleeve provides some additional structural support for the sleeve, and the sleeve provides structural protection for the end of the cable, connections to the PCB, the more fragile PCB and the connections passing through the end wall to the end of the plug.

In addition, one or more embodiments of the present invention provides a method of manufacturing an end connection for an electrical connector.

Wires 114a within a cable 114 are soldered to connections of an end connection plug 112. Plastic over-moulding 128 is applied over the soldered connections. A metal sleeve 130 is applied over a body portion of the plug and over the over-moulding covering the connections. The sleeve can be applied after the over-moulding covers the connections, in which case the sleeve is subsequently bonded to the over-moulding and/or the body portion.

Alternatively, the sleeve is applied to cover the connections with a space between the inner surface of the side wall of the sleeve and the connections, and then over-moulding injected into the space to thereby protect and insulate over the connections and also form a bond to the sleeve.

The claims defining the invention are as follows:

1. An electrical connector having an electrical end connector operatively and physically connected to an electrical cable via at least one electrical cable connection, a metal body portion and at least one electrical contact for transfer of electrical signals between at least one corresponding contact to which the electrical end connector is engaged, and the electrical end connector including a metal sleeve having at least one side wall, the side wall extending to cover the metal body portion, the metal body structurally supporting the side wall.

2. The electrical connector of claim 1, the sleeve providing protection for internal connections and components within the end connector.

3. The electrical connector of claim 1, the metal body portion providing structural support to the side wall by direct contact with the side wall of the sleeve.

4. The electrical connector of claim 1, the sleeve formed as a one piece component incorporating an integral said end wall and said side wall.

5. The electrical connector of claim 1, the opening in the end wall of the sleeve including a slot through which the at least one electrical contact extends on a portion connected to the metal body portion.

6. The electrical connector of claim 1, the metal body portion being in contact with an inside face of the end wall.

7. The electrical connector of claim 1, the sleeve being a pressed or stamped single component.

8. The electrical connector of claim 1, the metal sleeve including an end wall, the end wall including an opening through which the at least one electrical contact of the electrical end connector projects externally of the sleeve.

9. A method of manufacturing an electrical connector, including the steps of:
connecting an electrical cable to an end connector,
applying plastic over-moulding over the connection of the cable to the end connector;
applying a metal sleeve over a portion of the end connector and over the connection between the cable and end connector, a portion of the end connector extending from the sleeve to provide external connection to the cable; and
structurally supporting a side wall of the metal sleeve internally of the end connector by a metal body portion of the end connector.

10. The method of claim 9, including forming the metal sleeve as a one piece component prior to applying over the end connector.

11. The method of claim 9, the metal sleeve formed including an end wall with at least one opening therethrough, a portion of the body of the end connector extending through the at least one opening.

12. The method of claim 9, including bonding the metal sleeve to the over-moulding.

13. The method of claim 12, the bonding including bonding the sleeve to the over-moulding with an adhesive.

14. An electrical connector which, in use, electrically connects two electrical devices for power and/or data transfer from one said device to the other, the electrical connector having at least first and second portions, each of the first and second portions including a respective electrical end connection to electrically engage with a respective one of the electrical devices, the electrical end connections connected together by an electrical conductor, each of the first and second portions including a protective covering over respective first and second regions of the electrical conductor, and a third region of the electrical conductor intermediate the first and second regions being exposed from the protective coverings provided by the first and second portions.

15. The electrical connector of claim 14, including over-moulding along a significant length of each of the first and second portions.

16. The electrical connector of claim 15, the over-moulding extending over an end connector leaving electrical contacts exposed for electrical connection.

17. The electrical connector of claim 15 or 16, wherein the over-moulding is or includes a resilient or semi-rigid material.

18. The electrical connector of claim 17, wherein the resilient or semi-rigid material includes polyester or PPS plastic or other thermoset plastic, or combinations thereof.

19. The electrical connector of claim 14, wherein a region of the insulated cable is exposed from the over-moulding between the first and second portions

20. The electrical connector of claim 19, wherein the region of exposed insulated electrical conductor is insulated by a coating of PTFE.

21. The electrical connector of claim 20, wherein the coating of PTFE extends as insulation along the insulated electrical conductor within the over-moulding.

22. The electrical connector of claim 14, including at least one aperture in one or each of the first and second portions.

23. The electrical connector according to claim 14, including connection means provided to releasably connect the first and second portions directly or indirectly to each other or via one or more further portions.

24. The electrical connector according to claim 23, the connection means including at least one projection on one of the portions releasably engaging with a recess on another of the portions, or vice versa.

25. The electrical connector of claim 24, each said portion having at least one projection and at least one recess to engage respectively with a recess and a projection on an adjacent one of the portions.

26. The electrical connector of claim 14, including at least one intermediate portion covering at least one further region of the electrical conductor between the first and second portions.

27. The electrical connector of claim 26, including further said connection means releasably connecting the intermediate ones of the portions to the first and second portions.

28. An electrical connector which, in use, electrically connects two electrical devices for power and/or data transfer from one said device to the other, the electrical connector having at least first and second opposed end connectors electrically connected by an insulated electrical conductor, each of the first and second opposed end connectors including a protective covering over at least a portion of the respective end connector, and at least one of the end opposed end connectors having the covering extending over a distal end thereof and having exposed electrical contacts for connection with a said electrical device.

29. The electrical connector of claim 28, the protective covering providing a tension relief means to protect connection between the electrical conductor and the respective end connector.

30. The electrical conductor of claim 29, the exposed electrical contacts being contact terminals surrounded peripherally by over-moulded protective covering.

31. The electrical conductor of claim 28, the insulated electrical conductor including at least one flexible flat cable (FFC) electrically connecting the first and second opposed end connectors.

32. The electrical conductor of claim 31, one or each of the first and second opposed end connectors including a printed circuit board (PCB) supporting exposed electrical contacts for connection with a said electrical device.

33. The electrical conductor of claim 31 or 32, one or each of the first and second opposed end connectors including a/the printed circuit board (PCB) supporting electrical contacts for connection conductors of the FFC.
